(19) United States
(12) Patent Application Publication
(10) Pub. No.: US 2013/0111122 A1
(43) Pub. Date: May 2, 2013

(54) Method and apparatus for network table lookups

(71) Applicants: Haoyu Song, Cupertino, CA (US); Wang Xinyuan, Beijing (CN); Cao Wei, Cupertino, CA (US)

(72) Inventors: Haoyu Song, Cupertino, CA (US); Wang Xinyuan, Beijing (CN); Cao Wei, Cupertino, CA (US)

(73) Assignee: Futurewei Technologies, Inc., Plano, TX (US)

(21) Appl. No.: 13/285,728

(22) Filed: Oct. 31, 2011

(51) Int. Cl. G06F 12/00; G06F 12/06

(52) U.S. Cl. 711/105; 711/157; 711/147; 711/E12.079

(57) ABSTRACT

An apparatus comprising a plurality of memory components each comprising a plurality of memory banks, a memory controller coupled to the memory components and configured to control and select a one of the plurality of memory components for a memory operation, a plurality of address/command buses coupled to the plurality of memory components and the memory controller comprising at least one shared address/command bus between at least some of the plurality of memory components, and a plurality of data buses coupled to the memory components and the memory controller comprising at least one data bus between at least some of the memory components, wherein the memory controller uses a memory interleaving and bank arbitration scheme in a time-division multiplexing (TDM) fashion to access the plurality of memory components and the memory banks.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A relatively low cost, relatively low power, and relatively high performance solution for table lookups are desirable for network applications in routers and switches. Memory access patterns of table lookups fall into three main categories: read only, random, and small sized transactions. The Input/Output (I/O) frequency of Double Data Rate (DDR) Synchronous Dynamic Random Access Memory (SDRAM) devices has been steadily increasing. As a result, an increased amount of commands may be issued, and relatively larger quantity of data can be written to and read from a memory, e.g., in a given time period. However, due to timing constraints based on some DDRx timing parameters, achieving a relatively higher table lookup throughput with increased I/O frequency may require significantly increasing the I/O pin count on the search engine. While table lookups may be handled by Static Random-Access Memory (SRAM) devices or Ternary Content-Addressable Memory (TCAM) devices, a DDRx SDRAM is cheaper and more power efficient compared to a SRAM or a TCAM.

### SUMMARY

In one embodiment, the disclosure includes an apparatus comprising a plurality of memory components each comprising a plurality of memory banks, a memory controller coupled to the memory components and configured to control and select a one of the plurality of memory components for a memory operation, a plurality of address/command buses coupled to the plurality of memory components and the memory controller comprising at least one shared address/command bus between at least some of the plurality of memory components, and a plurality of data buses coupled to the memory components and the memory controller comprising at least one data bus between at least some of the memory components, wherein the memory controller uses a memory interleaving and bank arbitration scheme in a time-division multiplexing (TDM) fashion to access the plurality of memory components and the memory banks, and wherein the memory components comprise a generation of a Double Data Rate (DDR) Synchronous Dynamic Random Access Memory (SDRAM).

In another embodiment, the disclosure includes a network component comprising a receiver configured to receive a plurality of table lookup requests, and a logic unit configured to generate a plurality of commands indicating access to a plurality of interleaved memory chips and a plurality of interleaved memory banks for the chips via at least one shared address/command bus and one shared data bus.

In a third aspect, the disclosure includes a network apparatus implemented method comprising selecting a memory chip from a plurality of memory chips using a controller, selecting a memory bank from a plurality of memory banks assigned to the memory chips using the memory controller, sending a command over an Input/Output (I/O) pin of an address/command bus shared between some of the memory chips, and sending a data word over a data bus shared between the some of the memory chips, wherein the command is sent over the shared address/command bus and the data word is sent over the shared data bus in a multiplexing scheme.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a typical DDRx SDRAM system.

FIG. 2 is a schematic diagram of another embodiment of a typical DDRx SDRAM system.

FIG. 3 is a schematic diagram of an embodiment of an improved DDRx SDRAM system.

FIG. 4 is a schematic diagram of another embodiment of an improved DDRx SDRAM system.

FIG. 5 is a schematic diagram of an embodiment of a DDRx SDRAM architecture.

FIG. 6 is a schematic diagram of an embodiment of a timing diagram corresponding to the DDRx SDRAM architecture of FIG. 5.

FIG. 7 is a schematic diagram of an embodiment of another DDRx SDRAM architecture.

FIG. 8 is a schematic diagram of an embodiment of a timing diagram corresponding to the DDRx SDRAM architecture of FIG. 7.

FIG. 9 is a schematic diagram of another embodiment of a timing diagram corresponding to the DDRx SDRAM architecture of FIG. 7.

FIG. 10 is a flowchart of an embodiment of a table lookup method.

FIG. 11 is a schematic diagram of an embodiment of a network unit.

FIG. 12 is a schematic diagram of an embodiment of a general-purpose computer system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used herein, the term DDRx refers the xth generation of DDR memory, such as, for example, DDR2 refers to the 2^{nd} generation of DDR memory, DDR3 refers to the 3^{rd} generation of DDR memory, DDR4 refers to the 4^{th} generation of DDR memory, etc.

DDRx SDRAM performance may be subject to constraints due to timing parameters such as row cycling time (tRC), Four Activate Window time (tFAW), and row-to-row delay time (tRRD). For example, a memory bank may not be accessed again within a period of tRC, two consecutive bank accesses are required to be set apart by at least a period of tRRD, and no more than four banks may be accessed within a period of tFAW. With the advancement of technology, these timing parameters typically improve at a relatively slower pace compared to the increase in I/O frequency.

Although a DDRx SDRAM may be considered relatively slow due to its relatively long random access latency (e.g., a tRC of about 48 nanoseconds (ns)) and relatively slow core frequency (e.g., 200 Megahertz (MHz) for DDR3-1600), the DDRx SDRAM may have a relatively large chip capacity (e.g., 1 Gigabyte (Gb) per chip), multiple banks (e.g., eight banks in a DDR3), and a relatively high I/O interface frequency (e.g. 800 MHz for a DDR3, and a 3.2 Gigahertz (GHz) for a DDRx device on the SDRAM road map). These features may be used in a scheme to compensate for timing constraints.

Bank replication may be used as tradeoff to storage efficiency to achieve a relatively faster table lookup throughput. While the DDRx random access rate may be constrained by the tRC, if multiple banks retain the same copy of a lookup table, these banks may be accessed in an alternating or switching manner, i.e., via bank interleaving, to increase the table lookup throughput. However, at a relatively high clock frequency, two more timing constraints, tFAW and tRRD may limit the extent to which bank replication may be used. For example, within a time window of tFAW, one chip may not open more than four banks, and consecutive accesses to two banks may be constrained to be set apart by at least a period of tRRD.

For example, in the case of a 400 MHz DDR3-800 device, tFAW may be equal to about 40 ns, and tRRD may be equal to about 10 ns. Since a read request may require about two clock cycles to send a command, a memory access request may be read about every 5 ns in a 400 MHz device, and eight requests may be sent to eight banks in a 40 ns window. However, because of the timing constraints due to tFAW and tRRD, only four requests, e.g., one request every 10 ns, may be sent to four banks instead of eight requests to eight banks in a 40 ns window. At 400 MHz, this scheme may not limit performance because the DDRx burst size may be about eight words, e.g., a burst may require four clock cycles (at about 10 ns) to finish. Hence, at a maximum allowed command rate, a data bus bandwidth may already have been fully utilized, and there may be no need to further increase address bus utilization.

However, in the case of a 800 MHz DDR3-1600 device, while an interface clock frequency may double, tFAW and tRRD may remain unchanged or about the same as the case of an otherwise similar 400 MHz DDR3-800 device. When using a substantially similar command rate, as in the case of the 400 MHz DDR3-800 device, the data bus of the 800 MHz DDR3-1600 device may be only about 50 percent utilized. For relatively higher clock frequencies, data bus bandwidth utilization rate may be even lower. Thus, an increase in I/O frequency may not have increased table lookup throughput. Instead, using an increased number of chips may result in a higher table lookup throughput. However, performance scaling via increasing the number of chips may require using a relatively high pin count.

In the case of the 400 MHz DDR3-800 device, about 100 million searches per second, e.g., one read request per 10 ns, may be supported. Taking into consideration a bandwidth loss due to a plurality of additional constraints, e.g., refreshing and table updates, the search rate may be reduced to about 80 million searches per second. A solution based on coupling the operation of two chips by alternately accessing the two chips via a shared address bus, e.g., conducting a ping pong operation, may enable about 160 million searches per second, wherein both a shared address/command bus and a separate data bus may be fully utilized. The two chips solution may require about 65 pins and may be sufficient to support two table lookups per packet (one ingress lookup and one egress lookup) at about 40 Gigabit per second (Gbps) line speed. As such, the packet size may be about 64 bytes, and the maximum packet rate of a 40 Gbps Ethernet may be about 60 Million packets per second (Mpps). To support a similar type of table lookups at 400 Gbps line speed (e.g. 600 Mpps), using the same two chip solution may require about 650 pins which may be impractical or costly.

Disclosed herein is a system and method for using one or more commodity and relatively low cost DDRx SDRAM device, e.g., DDR3 SDRAM or a DDR4 SDRAM, to achieve relatively high random access table lookups without requiring a significant increase in pin count. A scheme to avoid the violation of the critical timing constraints such as tRC, tFAW, and tRRD may be based on applying shared bank and chips access interleaving techniques at relatively high I/O clock frequencies. Such a scheme may increase the table lookup throughput by increasing the I/O frequency without a substantial increase in I/O pin count. Thus, the scheme may ensure a smooth system performance migration path that may follow the progress of DDRx technology.

A high performance system according to the disclosure may be based on multiple DDRx SDRAM chips that share a command/address bus and a data bus in a time-division multiplexing (TDM) fashion. By interleaving bank and chip accesses to these chips, both the command bus and the data bus may be substantially or fully utilized at relatively high I/O speed, e.g., greater than or equal to about 400 MHz. A further advantage of this interleaving scheme is that the accesses to each chip may be properly spaced to comply with DDRX timing constraints. This scheme may allow scaling table lookup performance with I/O frequency without significantly increasing the pin count. Multiple tables may be searched in parallel, and each lookup table may be configured to support a different lookup rate, with a storage/throughput tradeoff.

In different embodiments, using the scheme above, a 400 MHz DDR3 SDRAM may support about 100 Gbps line speed table lookups, an 800 MHz DDR3 SDRAM may support about 200 Gbps line speed table lookups, and a 1.6 GHz DDR3/4 SDRAM may support about 400 Gbps line speed table lookups. For instance, an about 200 Gbps line speed table lookup may be achieved using multiple DDR3-1600 chips with only about 80 pins connected to a search engine. In another scenario, an about 400 Gbps line speed table lookup may be achieved using multiple DDR4 SDRAMs that operate at about 1.6 GHz I/O frequency, and by adding less than about 100 pins to the memory sub-system. Memory chip vendors (e.g., Micron) may package multiple dies to support high performance applications. A system based on multiple DDRx SDRAM chips as described above may utilize DDRx SDRAM vertical die-stacking and packaging for network applications. In an embodiment, a through silicon via (TSV) stacking technology may be utilized to generate a relatively compact table lookup package. Further, the package may not need to use a serializer/deserializer (SerDes), which may reduce latency and power.

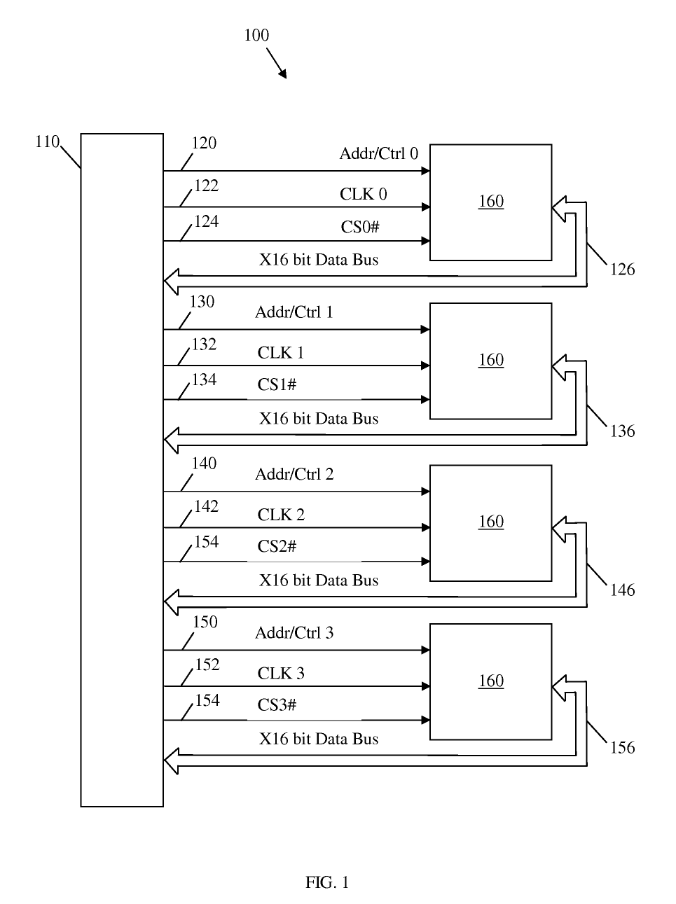

FIG. 1 illustrates an embodiment of a typical DDRx SDRAM system 100 that may be used in a networking system. The DDRx SDRAM system 100 may comprise a DDRx SDRAM controller 110, about four DDRx SDRAMs 160, and about four bi-directional data buses 126, 136, 146, and 156, which may be 16-bit data buses. In other embodiments, the DDRx SDRAM system 100 may comprise different quantities of the components than shown in FIG. 1. The components of the DDRx SDRAM system 100 may be arranged as shown in FIG. 1.

The DDRx SDRAM controller 110 may be configured to exchange control signals with the DDRx SDRAMs 160. The DDRx SDRAM controller 110 may act as a master of the DDRx SDRAMs 160, which may comprise DDR3 SDRAMs, DDR4 SDRAMs, other DDRx SDRAMs, or combinations thereof. The DDRx SDRAM controller 110 may be coupled to the DDRx SDRAMs 160 via about four corresponding address/control (Addr/Ctrl) links 120 (Addr/Ctrl 0), 130 (Addr/Ctrl 1), 140 (Addr/Ctrl 2), 150 (Addr/Ctrl 3), about four clock (CLK) links 122 (CLK 0), 132 (CLK 1), 142 (CLK 2), 152 (CLK 3), and about four chip select (CS) links 124 (CS0#), 134 (CS1#), 144 (CS2#), and 154 (CS3#). Each link may be used to exchange a corresponding signal. The address/control signals (also referred to herein as address/command signals), the clock signals, and the chip select signals may be input signals to the DDRx SDRAMs 160. The address/control signals may comprise address and/or control information, and the clock signals may be used to clock the DDRx SDRAMs 160. Further, the DDRx SDRAM controller 110, may select a desired chip by pulling a chip select signal low. The bi-directional data buses 126, 136, 146, and 156 may be coupled to the DDRx SDRAMs 160 and the DDRx controller 110 and may be configured to transfer about 16-bit data words between the DDRx controller 110 and each of the DDRx SDRAMs. Typically, to boost table lookup performance in DDRx SDRAM systems, the number of chips, memory controllers, and pins may be increased. However, such scaling up of performance to typical DDRx SDRAM systems, such as the DDRx SDRAM system 100, to boost table lookup performance may cause or introduce design bottlenecks due to the increased number of pins and required controller resources.

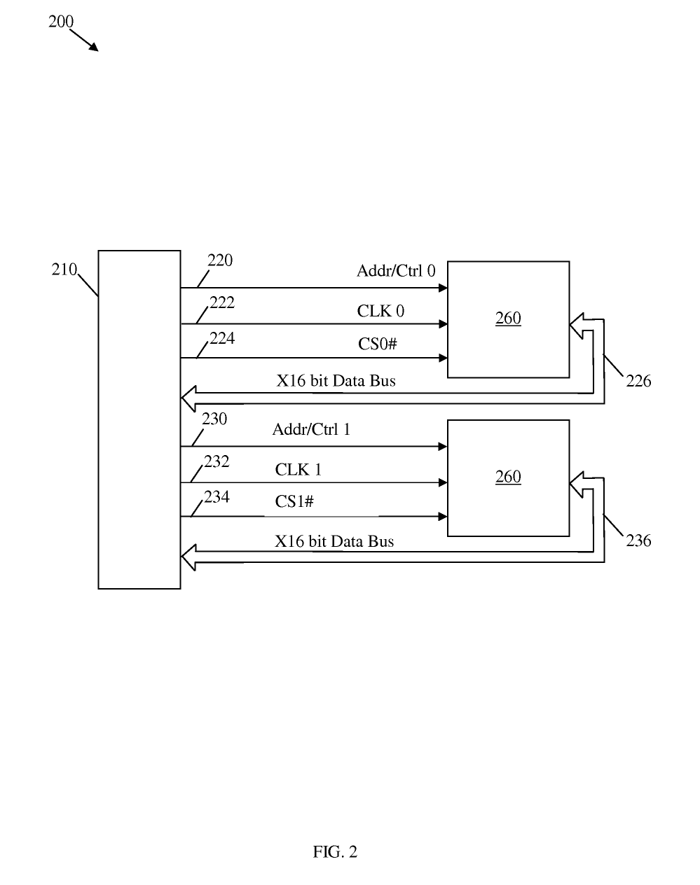

FIG. 2 illustrates an embodiment of another typical DDRx SDRAM system 200 that may be used in a networking system, e.g., using an I/O frequency less than about 400 MHz. The DDRx SDRAM system 200 may comprise a DDRx SDRAM controller 210, about two DDRx SDRAMs 260, and about two bi-directional data buses 226 and 236, which may be 16-bit data buses. The DDRx SDRAM controller 210 may be coupled to the DDRx SDRAMs 260 via about two corresponding Addr/Ctrl links 220 (Addr/Ctrl 0), 230 (Addr/Ctrl 1), about two clock (CLK) links 222 (CLK 0), 232 (CLK 1), and about two CS links 224 (CS0#) and 234 (CS1#).

Each link may be used to exchange a corresponding signal. The address/control signals, the clock signals, and the chip select signals may be input signals to the DDRx SDRAMs 260. The address/control signals may comprise address and/or control information, and the clock signals may be used to clock the DDRx SDRAMs 260. Further, the DDRx SDRAM controller 210, may select a desired chip by pulling a chip select signal low. The bi-directional data buses 226 and 236 may be coupled to the DDRx SDRAMs 260 and the DDRx controller 210 and may be configured to transfer about 16-bit data words between the DDRx controller 210 and each of the DDRx SDRAMs. In other embodiments, the DDRx SDRAM system 200 may comprise different quantities of components than shown in FIG. 2. The components of the DDRx SDRAM system 200 may be arranged as shown in FIG. 2. The components of the DDRx SDRAM system 200 may be configured substantially similar to the corresponding components of the DDRx SDRAM system 100.

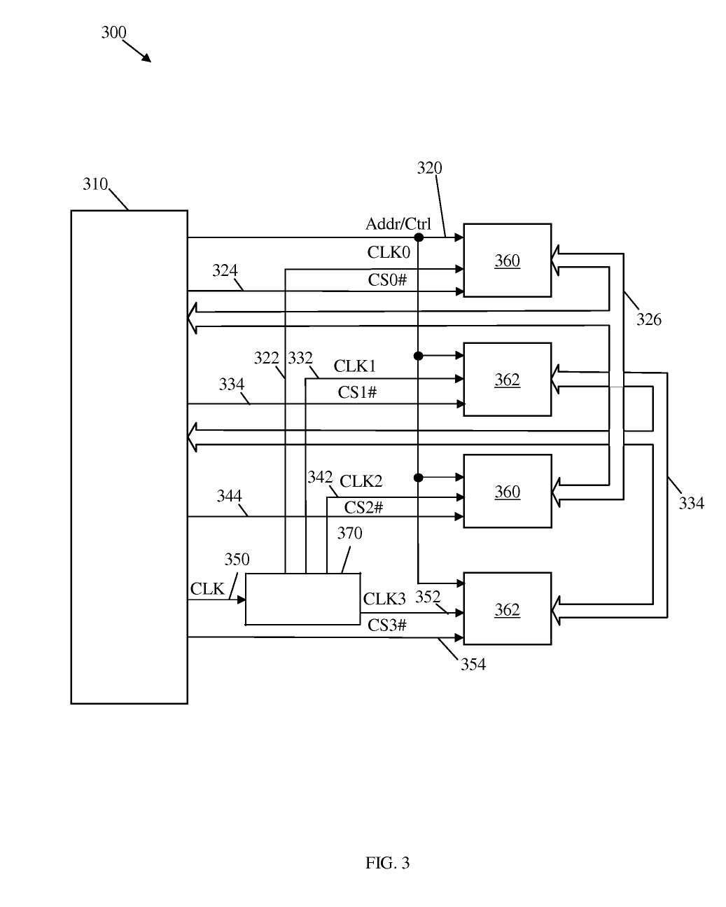

FIG. 3 illustrates embodiment of an improved DDRx SDRAM system 300 that may compensate for some of the disadvantages of the DDRx SDRAM system 100. The DDRx SDRAM system 300 may comprise a DDRx SDRAM controller 310, about two DDRx SDRAMs 360, about two DDRx SDRAMs 362, about two shared bi-directional data buses 326 and 334 (e.g., 16-bit bidirectional data buses), and a clock regulator 370. The components of the DDRx SDRAM system 300 may be arranged as shown in FIG. 3.

The DDRx SDRAM controller 310 may be configured to exchange control signals with the DDRx SDRAMs 360 and 362. The DDRx SDRAM controller 310 may act as a master of the DDRx SDRAMs 360 and 362, which may comprise DDR3 SDRAMs, DDR4 SDRAMs, other DDRx SDRAMS, or combinations thereof. The DDRx SDRAM controller 310 may be coupled to the DDRx SDRAMs 360 and 362, via about one shared Addr/Ctrl link 320 (Addr/Ctrl 0), about four clock (CLK) links 322 (CLK 0), 332 (CLK 1), 342 (CLK 2), 352 (CLK 3), and about four CS links 324 (CS0#), 334 (CS1#), 344 (CS2#), and 354 (CS3#). Each link may be used to exchange a corresponding signal, as described above. The bi-directional data buses 326 and 334 may couple to the DDRx SDRAMs 360 and 362 to the DDRx controller 310, and may be configured to transfer about 16-bit data words between the DDRx controller 310 and each of the DDRx SDRAMs. DDRx controller 310 may also be referred to as a search engine or logic unit. In some embodiments, the DDRx controller 310 may be, for example, a field-programmable gate array (FPGA), an Application-Specific Integrated Circuit (ASIC), or a network processing unit (NPU).

Specifically, the DDRx SDRAMs 360 may be coupled to a shared data bus 326 and may be configured to share the data bus 326 for data transactions (with the DDRx SDRAM controller 310). Similarly, the DDRx SDRAMs 362 may be coupled to a shared data bus 334 and may be configured to share the data bus 334 for data transactions. Sharing the data buses may involve an arbitration scheme, e.g., a round-robin arbitration during which the rights to access the bus are granted to either the DDRx SDRAMs 360 or the DDRx SDRAMs 362, e.g., in a specified order. In an embodiment, the I/O frequency of DDRx SDRAM system 300 may be about 800 MHz, and the table lookup performance may be about 400 Mpps.

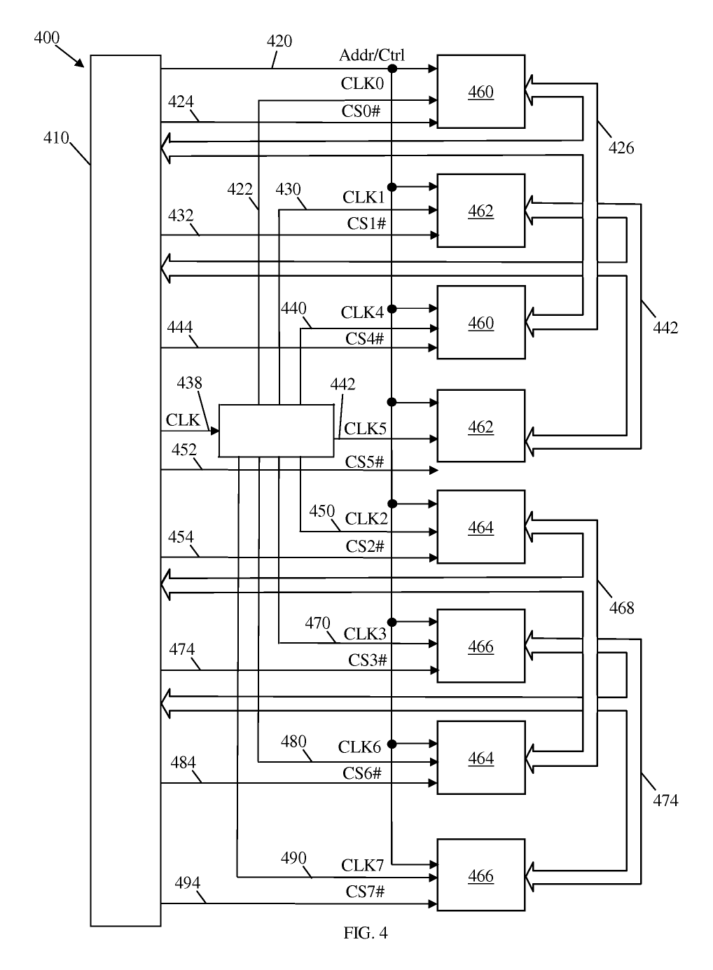

The DDRx SDRAM system 300 may be scaled up to boost table lookup performance without significantly increasing the number of pins and controller resources. FIG. 4 illustrates an embodiment of a scaled up DDRx SDRAM system 400. The DDRx SDRAM system 400 may comprise a DDRx SDRAM controller 410, about two DDRx SDRAMs 460, about two DDRx SDRAMs 462, about two DDRx SDRAMs 464, about two DDRx SDRAMs 466, and about four shared (16-bit) bi-directional data buses 426, 442, 466, and 474. The components of the DDRx SDRAM system 400 may be arranged as shown in FIG. 4.

The DDRx SDRAM controller 410 may act as a master of the DDRx SDRAMs 460, 462, 464 and 466, which may comprise DDR3 SDRAMs or DDR4 SDRAMs, other DDRx SDRAM, or combinations thereof. The DDRx SDRAM controller 410 may be coupled to the DDRx SDRAMs 460, 462, 464 and 466, via about one shared Addr/Ctrl link 420 (Addr/Ctrl 0), about eight clock (CLK) links 422 (CLK 0), 430 (CLK 1), 450 (CLK 2), 470 (CLK 3), 440 (CLK 4), 442 (CLK 5), 480 (CLK 6), 490 (CLK 7), and about eight chip select (CS) links 424 (CS0#), 432 (CS1#), 454 (CS2#), 474 (CS3#), (CS0#), 432 (CS1#), 454 (CS2#), and 474 (CS3#). Each link may be used to exchange a corresponding signal, as described above. The bi-directional data buses 426, 442, 466, and 474 may couple the DDRx SDRAMs 460, 462, 464 and 466 to the DDRx controller 410, and may be configured to transfer about 16-bit data words between the DDRx controller 410 and each of the DDRx SDRAMs.

Specifically, the DDRx SDRAMs 460 may be coupled to a shared data bus 426 and may be configured to share the data bus 426 for data transactions (with the DDRx SDRAM controller 410). Similarly, the DDRx SDRAMs 462, 464, and 466 may be coupled to a shared data buses 442, 468, and 474, respectively, and may be configured to share the data buses 442, 468, and 474 for data transactions. Sharing the data buses may involve an arbitration scheme, e.g., a round-robin arbitration during which the rights to access the bus are granted to either the DDRx SDRAMs 460, 462, 464, and 466, e.g., in a specified order. In an embodiment, the I/O frequency of DDRx SDRAM system 400 may be about 1.6 GHz, and the table lookup performance may be about 800 Mpps.

Different DDRx SDRAM configurations may comprise different I/O frequencies, different numbers of chips, and/or different pin counts, and hence may result in different table lookup throughputs. Table 1 summarizes the lookup performance of different embodiments of DDRx SDRAM configurations for different I/O frequencies, where the same timing parameters may apply to all embodiments. For example, a system comprising an I/O frequency of about 400 MHz, about two chips and a pin count of about X (where X is an integer) may provide about 200 Mega searches per second (Msps). Another system comprising an I/O frequency of about 800 MHz, about four chips and a pin count of about X+2 (the actual number of pins could be slightly more than X+2 due to pins such as clock, ODT, etc. that cannot be shared—the number 2 here only reflects the extra CS pins) may provide about 400 Msps. A third system comprising an I/O frequency of about 1066 MHz, about six chips, and a pin count of about X+4 (the actual number of pins may be slightly more than X+4 due to pins such as clock, ODT, etc. that cannot be shared—the number 4 here only reflects the extra CS pins) may provide about 533 Msps. A fourth system comprising an I/O frequency of about 1.6 GHz, about eight chips, and a pin count of about X+6 (the actual number of pins may be slightly more than X+6 due to pins such as clock, ODT, etc. that cannot be shared—the number 6 here only reflects the extra CS pins) may provide about 800 Msps. A fifth system comprising an I/O frequency of about 3.2 GHz, about 16 chips, and a pin count of about X+14 (the actual number of pins may be slightly more than X+16 due to pins such as clock, ODT, etc. that cannot be shared—the number 14 here only reflects the extra CS pins) may provide about 1.6 Giga searches per second (Gsps). The DDRx SDRAM systems 300 and 400 described above may be based on a DDRx SDRAM configuration comprising about four chips and about eight chips, respectively, as shown in Table 1.

TABLE 1
Lookup performance for different DDRx SDRAM configuration

| | | Table lookup | |
|---|---|---|---|
| I/O Clock frequency | Chip count | throughput | Pin Count |
| 400 MHz | 2 | 200 Msps | X |
| 800 MHz | 4 | 400 Msps | X + 2 |
| 1066 MHz | 6 | 533 Msps | X + 4 |
| 1.6 GHz | 8 | 800 Msps | X + 6 |
| 3.2 GHz | 16 | 1.6 Gsps | X + 14 |

Further, using a bank replication scheme in the systems above, as described in details below, different number of lookup tables may be implemented and different configurations may support different lookup throughputs. Table 2 summarizes the table lookup throughput in Mpps that may be achieved for different configurations with different numbers of tables that use the bank replication scheme. For example, in the case of one lookup table, a bank replication of eight banks per chip, which may be substantially identical, an I/O frequency of about 400 MHz, and a table throughput of about 200 Mpps may be achieved. In another case of one lookup table, a bank replication of eight banks per chip, and an I/O frequency of about 800 MHz, and a table throughput of about 800 Mpps may be achieved. In another case of two lookup tables, a bank replication of four banks per chip, an I/O frequency of about 400 MHz, and a table throughput of about 100 Mpps may be achieved. Table 2 shows other cases for using up to 128 lookup tables and up to 16 groups of identical chips.

TABLE 2
Table lookup throughput for different number of tables (Mpps)

| # of | | Clock frequency (MHz) | | | |
|---|---|---|---|---|---|
| tables | Bank Replication | 400 | 800 | 1600 | 3200 |
| 1 | 8 bank replication/chip, | 200 | 400 | 800 | 1600 |
| | all chips are identical | | | | |
| 2 | 4 bank replication/chip, | 100 | 200 | 400 | 800 |
| | all chips are identical | | | | |
| 4 | 2 bank replication/chip, | 50 | 100 | 200 | 400 |
| | all chips are identical | | | | |
| 8 | No replication, | 25 | 50 | 100 | 200 |
| | all chips are identical | | | | |
| 16 | 2 groups of identical chips | 12.5 | 25 | 50 | 100 |
| 32 | 4 groups of identical chips | — | 12.5 | 25 | 50 |
| 64 | 8 groups of identical chips | — | — | 12.5 | 25 |
| 128 | 16 groups of identical chips | — | — | — | 12.5 |

According to Table 2, a user may choose a configuration suitable for a specified application. A user may also arbitrarily partition the bank replication ratio according to the lookup throughput requirements for different lookup tables. For example, if a first lookup table requires about twice the number of memory accesses compared to a second lookup table for each packet, a user may choose to assign to the first lookup table about double the number of replicated banks compared to the number replicated banks assigned to the second lookup table.

In order to keep a memory access pattern and sustain a table lookup throughput, a table size may not exceed a bank size. In an embodiment, the bank size may be about 128 Mbits for a 1 Gbit DDR3 chip, which may be a sufficient size for a multitude of network applications. In case the table size exceeds the bank size, the table may be split into two banks, which may reduce the table lookup throughput by half. A bank may also be partitioned to accommodate more than one table per bank, which may also reduce lookup throughput. Alternatively, two separate sets that each use the bank sharing scheme may be implemented to maintain the lookup throughput at about twice the cost.

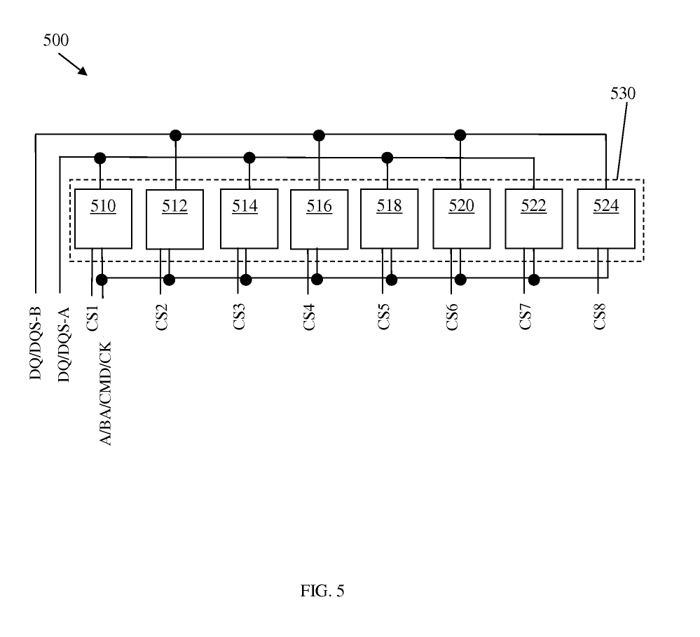

FIG. 5 illustrates an embodiment of a DDR3 SDRAM architecture 500 that may be used in a networking system. The DDR3 SDRAM architecture 500 may be used as a DDRx SDRAM configuration for operating a plurality of chips in parallel via bus sharing, e.g., to scale performance with I/O frequency. The DDR3 SDRAM architecture 500 may comprise a chip group 530 comprising eight chips 510, 512, 514, 516, 518, 520, 522, and 524, which may each comprise a DDR3 SDRAM. The DDR3 SDRAM architecture 500 may further comprise a first data bus for (DQ/DQS)-A, a second data bus for DQ/DQS-B, where DQ is a bi-directional tri-state data bus to carry input and output data to and from the DDRx memory units and DQS are corresponding strobe signals that are used to correctly sample the data on DQ. The DDR3 SDRAM architecture 500 may also comprise an address/command bus for (A/BA/CMD/CK) where A is the address, BA is the bank address that is used to select a bank, CMD is the command which is used to instruct the memory for specific functions, and CK is the clock which is used to clock the memory chip. In an embodiment, the DDR3 SDRAM architecture 500 may comprise about eight 1.6 GHz chips comprising DDR3 SDRAMs 510, 512, 514, 516, 518, 520, 522, and 524. Each chip in the chip group 530 may be coupled to about eight memory banks. The number of chips and the number of memory banks may vary in different embodiments. For example, the number of chips may be about two, about four, about six, about eight, or about 16. The number of memory banks may be about two, about four, or about eight. The components of the DDR3 SDRAM architecture 500 may be arranged as shown in FIG. 5.

While the DQ bus can be shared, extra care should be taken with the DQS pins. Since DQS has a pre-amble and a post-amble time, its effective duration may exceed four clock cycles when the burst size is 8. If the two DQS signals are combined as one, there can be signal confliction that results in corruption of the DQS signal. To avoid the DQS confliction, several solutions are possible: (1) only share the DQ bus but not the DQS signals. Each DRAM chip has its own DQS signal for data sampling on the shared DQ bus. This would slightly increase the total number of pins. (2) DQS signal can still be shared. A circuit-level technique (e.g. a resistor network) and switch-changeover technique (e.g. a MOSFET) may be used to cancel the conflictions between the different DQS signals when merging them. This would slightly increase the power consumption and the system complexity. Note that the future multi-die packaging technology such as TSV may solve the DQS confliction problem at the package level.

The chips in the chip group 530 may be coupled to the same address/command bus ABA/CMD/CK and may be configured to share this bus to exchange addresses and commands. A first group of chips, for example, chips 510, 514, 518 and 522 may be configured to exchange data by sharing the data bus DQ/DQS-A, and a second group of chips, for example, chips 512, 516, 520 and 524, may be configured to exchange data by sharing data bus DQ/DQS-B. A chip in the DDR3 SDRAM architecture 500 may be selected at any time by a chip select signal that is exchanged with a controller. The chips 510, 512, 514, 516, 518, 520, 522, and 524 may be configured to exchange chip select signals CS1, CS2, CS3, CS4, CS5, CS6, CS7, and CS8, respectively. For instance, every two clock cycles, a read command may be issued to a chip, targeting a specific memory bank coupled to the chip. For example, read commands may be issued in a round-robin scheme from chip 510 to chip 524 to target bank #0 to bank #7. For example, the first eight read commands (where each individual command is issued every two cycles) may target bank #0 of chips 510, 512, 514, 516, 518, 520, 522, and 524, in that order. The next eight read commands may target bank #1 of chips 510, 512, 514, 516, 518, 520, 522, and 524. Each memory bank may be accessed every about 64 cycles (e.g., every about 40 ns for 1.6 GHz DDR3 SDRAM), and each chip may be accessed every about eight cycles (e.g., every about 5 ns for 1.6 GHz DDR3 SDRAM, which may satisfy tRRD). Four consecutive banks in a given chip may be accessed every about 32 clock cycles (e.g., every about 20 ns for 1.6 GHz DDR3 SDRAM, which may satisfy tFAW). While the DDR3 SDRAM architecture 500 may comprise more chip select pins compared to a design based on 800 MHz DDR3, such as the DDRx SDRAM system 100, the DDRx SDRAM architecture 500 may support substantially more searches, e.g., about 800 million searches per second.

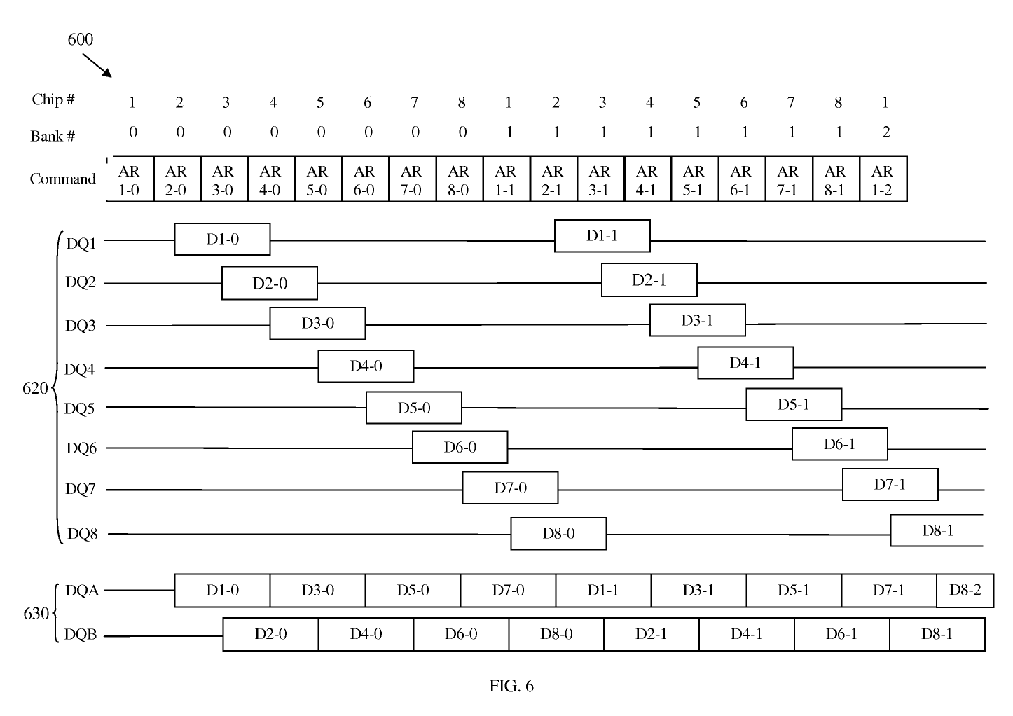

FIG. 6 illustrates an embodiment of a timing diagram 600 that may indicate the behavior of memory access patterns of a DDRx SDRAM architecture comprising about eight chips, with each chip coupled to about eight memory banks, e.g., based on the DDR3 SDRAM architecture 500. For example, chip #0, chip #1, chip #2, chip #3, chip #4, chip #5, chip #6, and chip #7 of the timing diagram 600 may correspond to chips 510, 512, 514, 516, 518, 520, 522, and 524 in the DDR3 SDRAM architecture 500, respectively. The timing diagram 600 shows an address/control or address/command bus 620 comprising eight I/O pins DQ1, DQ2, DQ3, DQ4, DQ5, DQ6, DQ7, and DQ8, and in addition two data buses 630, DQA and DQB. The timing diagram 600 also shows a plurality of data words and commands along a time axis, which may be represented by a horizontal line with time increasing from left to right. The data words and commands are represented as Di-j and ARi-j, respectively. The indexes i and j are integers, where i indicates a chip and j indicates a memory bank. For example, D4-0 may correspond to a data word targeted to chip #4 and a memory bank #0, and AR1-2 may indicate a command issued to chip #1 and a memory bank #2. The timing diagram 600 also shows the chip indices (“chip”) and bank indices (“bank”).

The timing diagram 600 indicates the temporal behavior of memory access patterns and commands of a DDRx SDRAM architecture comprising eight chips, such as the DDR3 SDRAM architecture 500. Each command ARi-j may comprise an active command issued in one clock cycle and a read command issued in a subsequent clock cycle. Note, each DDRx read procedure may require two commands: an Active command that is used to open a row in a bank, and a Read command that is used to provide the column address to read. The active commands may be issued in odd-number clock cycles, and the corresponding read commands may be issued in even-number clock cycles. The commands may be issued in a round-robin scheme, as described above. The data words Di-j may be each about four cycles long and may be placed on the data buses 630. With each clock cycle, an action command or a read command may be issued.

A command AR1-0 comprising an active command for the first cycle and a read command for a second cycle may be issued to chip #1 and memory bank #0. At a third cycle, a command AR2-0 comprising an action command for the third cycle and a read command for a fourth cycle may be issued to chip #2 and memory bank #0. After the expiration of several clock cycles and at the beginning of a subsequent clock cycle (shown as clock cycle 4 in FIG. 6 for ease of illustration, but may be any number of clock cycles, for example, in some embodiments, it may be more than 10 clock cycles, depending on the chip specification), a data word D1-0 may appear on a DQA bus. This latency between the time when the read command is issued and the time when the data appears on DQ is the read latency (tRL). The data word D1-0 may comprise data from chip #1 and memory bank #0. At a fifth clock cycle, a command AR3-0 comprising an active command and a read command for a sixth cycle may be issued to chip #3 and memory bank #0. At the beginning of a sixth clock cycle, a data word D2-0 may appear on a DQ2 pin of the address/command bus. The data word D2-0 may comprise an address or a command targeted to chip #1 and memory bank #0. At about the same time, at the sixth clock cycle, a data word D2-0 may appear on a DQB bus. The data word D2-0 may comprise data targeted to chip #2 and memory bank #0. At the sixth cycle, the system may enter a steady state, where at each subsequent clock cycle, an action or a read command may be issued in a manner that fully (at about 100 percent) or substantially utilizes the address/command bus 620 and the two data buses 630. Although data word D2-0 is shown as appearing on the DQ after four clock cycles, this is for illustration purposes only. The data word may show up on the DQ after a fixed latency of tRL which is not necessarily four cycles as shown.

Compared to a DDR3 SDRAM that comprises an 8-bit pre-fetch size or burst size, a future generation of DDRx SDRAM may have a higher I/O frequency and may use a 16-bit pre-fetch size. In such a DDRx SDRAM, a burst may need about eight clock cycles to transfer, during which about four read commands may be issued. For this reason, at least about four chips may be grouped together, to share four data buses, in contrast to the two buses that may be shared in the case of a DDR3 SDRAM. On the other hand, the DDR3 SDRAM and such a DDRx SDRAM may have substantially identical schemes to increase lookup performance in terms of number of searches per second, e.g., based on different I/O frequencies. A DDRx chip with burst size of 16 may have substantially the same data bus width as a DDR3 chip, and thus each read request may retrieve twice as many data from a memory. If the width of a data bus on a DDRx chip with burst size of 16 is reduced to half, then DDRx SDRAM configurations based on both DDR3 and DDRx with burst size of 16 may have a substantially similar number of pins and substantially the same memory transaction size (e.g. a data unit size for both a x8 DDR-x with burst size of 16 and a x16 DDR3 may be about 128-bits).

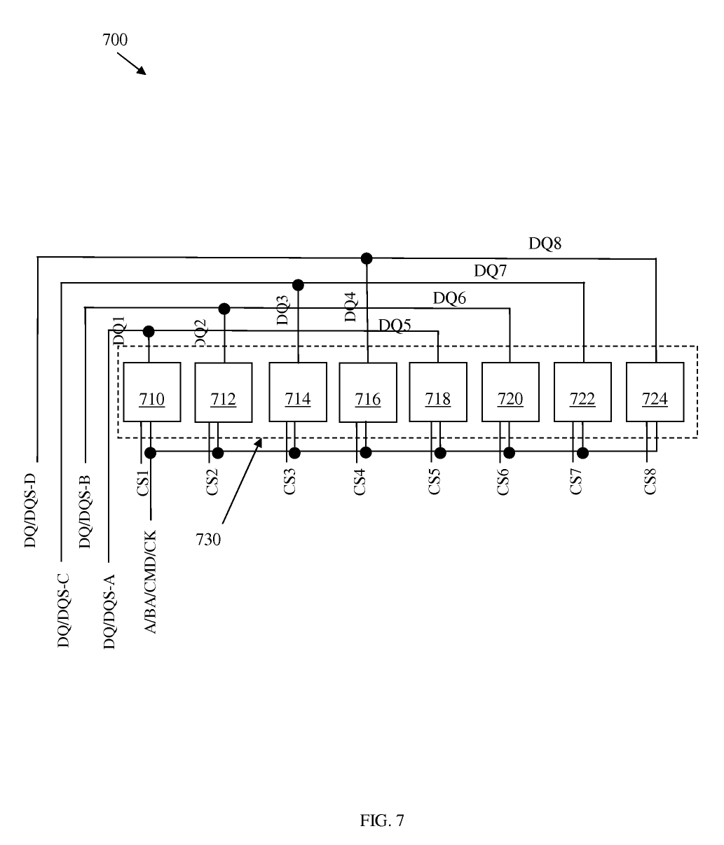

FIG. 7 illustrates an embodiment of a DDRx SDRAM (with burst size of 16) architecture 700 that may be used in a networking system. Similar to the DDR3 SDRAM architecture 500, the DDRx SDRAM (with burst size of 16) architecture 700 may be used as a DDRx SDRAM configuration for operating a plurality of chips in parallel via bus sharing, e.g., to scale performance with I/O frequency. The DDRx SDRAM (with burst size of 16) architecture 700 may comprise a chip group 730 comprising eight chips 710, 712, 714, 716, 718, 720, 722, and 724. The chips may each comprise a DDRx SDRAM (with burst size of 16). The DDRx SDRAM (with burst of 16) architecture 700 may further comprise a data bus for DQ/DQS-A, a data bus for DQ/DQS-B, a data bus for DQ/DQS-C, a data bus labeled DQ/DQS-D, as well as an address/command bus labeled A/BA/CMD/CK. Each chip in the chip group 730 may be coupled to about eight memory banks. The number of chips and the number of memory banks may vary in different embodiments. For example, the number of chips may be about two, about four, about six, about eight or about 16. The number of memory banks may be about two, about four, or about eight. However, for a particular I/O frequency, the configuration of the number of chips may be fixed. Furthermore, the number of banks for each generation of DDR SDRAM may also be fixed (e.g., both DDR3 and DDR4 may have only 8 banks per chip). The architecture depicted in FIG. 7 fully may use or substantially use the full bandwidth of both the data bas and the address/command bus. The components of the DDR4 SDRAM architecture 700 may be arranged as shown in FIG. 7.

The chips in the chip group 730 may be coupled to the same address/command bus A/BA/CMD/CK and may be configured to share this bus to exchange addresses and commands. A first group of chips, for example, chips 710 and 718 may be configured to exchange data by sharing the data bus DQ/DQS-A, and a second group of chips, for example, chips 712 and 720, may be configured to exchange data by sharing data bus DQ/DQS-B, and a third group of chips, for example, chips 714 and 722, may be configured to exchange data by sharing data bus DQ/DQS-B, and a fourth group of chips, for example, chips 716 and 724, may be configured to exchange data by sharing data bus DQ/DQS-D. A chip in the DDR4 SDRAM architecture 700 may be selected by a chip select signal that is exchanged with a controller. The chips 710, 712, 714, 716, 718, 720, 722, and 724 may be configured to exchange chip select signals CS1, CS2, CS3, CS4, CS5, CS6, CS7, and CS8, respectively. For instance, every two clock cycles, a read command may be issued to a chip, e.g., targeting a specific memory bank coupled to the chip. For example, read commands may be issued in a round-robin scheme from chip 710 to chip 724 to target bank #0 to bank #7. For example, the first eight read commands (where each individual command is issued every two cycles) may target bank #0 of chips 710, 712, 714, 716, 718, 720, 722, and 724, in that order. The next eight read commands may target bank #1 of chips 710, 712, 714, 716, 718, 720, 722, and 724.

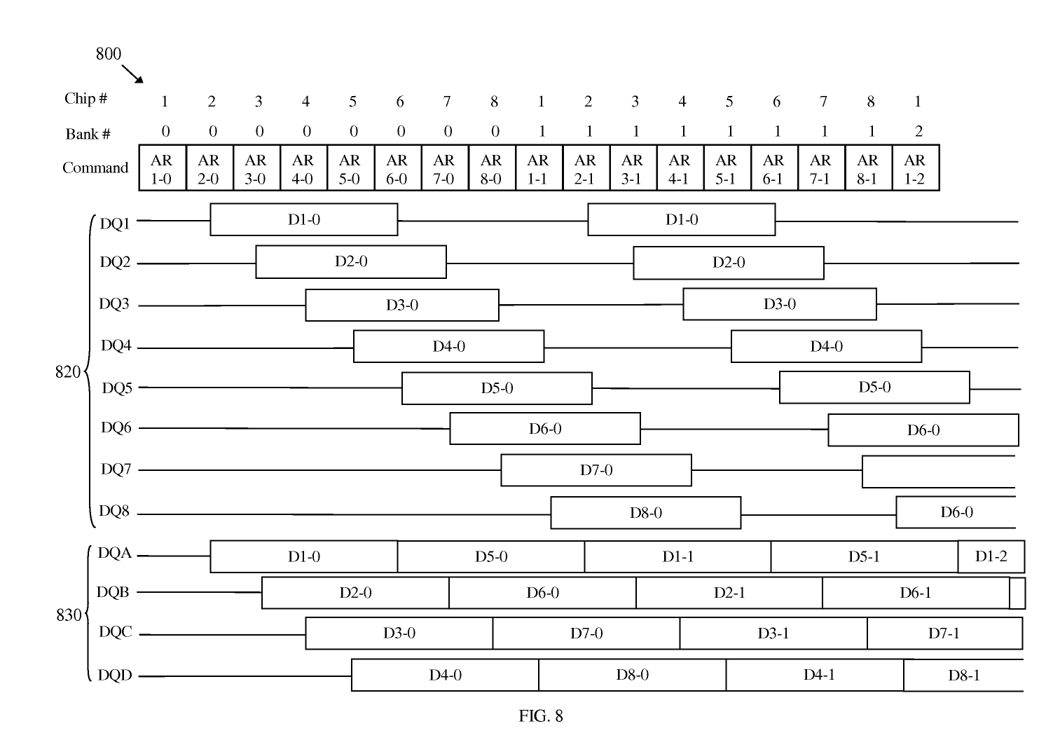

FIG. 8 illustrates an embodiment of a timing diagram 800 that may indicate the behavior of memory access patterns of a DDRx SDRAM architecture comprising about eight chips, with each chip coupled to about eight memory banks, e.g., based on the DDRx SDRAM (with burst size of 16) architecture 700. For example, chip #1, chip #2, chip #3, chip #4, chip #5, chip #6, chip #7, and chip #8 of the timing diagram 800 may correspond to chips 710, 712, 714, 716, 718, 720, 722, and 724 in the DDRx SDRAM (with burst size of 16) architecture 700, respectively. The timing diagram 800 shows the data bus 820 comprising eight groups of I/O data buses DQ1, DQ2, DQ3, DQ4, DQ5, DQ6, DQ7, and DQ8, where DQ1 is the data bus of chip #1, DQ2 is the data bus of chip #2, etc., and the four shared data buses 830, DQA, DQB, DQC, and DQD that each connect to the memory controller. DQ1 and DQ5 are merged onto DQA, DQ2 and DQ6 are merged onto DQB, DQ3 and DQ7 are merged onto DQC, and DQ4 and DQ8 are merged onto DQD. Each of data buses DQ1 DQ2, DQ3, DQ4, DQ5, DQ6, DQ7, and DQ8 may comprise 8, 16, or 32 pins. The timing diagram 800 also shows a plurality of data words and commands along a time axis, wherein the time axis may be represented by a horizontal line with time increasing from left to right. The data words and commands are represented as Di-j and ARi-j, respectively. The indexes i and j are integers, where i indicates a chip, and j indicates a memory bank. For example, D4-0 may correspond to a data word from chip #4 and a memory bank #0, and AR1-2 may indicate a command issued to chip #1 and a memory bank #2. The timing diagram 800 also shows the chip indices (“chip”) and bank indices (“bank”).

The timing diagram 800 indicates the temporal behavior of memory access patterns and commands of a DDRx SDRAM architecture comprising eight chips, such as the DDRx SDRAM (with burst size of 16) architecture 700. Each command ARi-j may comprise an active command issued in one clock cycle and a read command issued in a subsequent clock cycle. The active and read commands may be issued to the same chip in an alternative manner. For example, the active commands may be issued in odd-number clock cycles, and the read commands may be issued in even-number clock cycles. Note, as stated above, a read operation may include two commands: an active command (open bank and row) followed by a read command (read column data). The commands may be issued in a round-robin scheme. The data words Di-j may be each about eight cycles long and may be placed on the address/command bus 820 or on the data buses 630. With each clock cycle, an active command or a read command may be issued.

At a first cycle, a command AR1-0 comprising an active command for the first cycle and a read command for a second cycle may be issued to chip #1 and memory bank #0. At a third cycle, a command AR2-0 comprising an action command for the third cycle and a read command for a fourth cycle may be issued to chip #2 and memory bank #0. After the latency of tRL, a data word D1-0 may appear on a DQA bus. The data word D1-0 may comprise data from chip #1 and memory bank #0. At a fifth clock cycle, a command AR3-0 comprising an action command and a read command for a sixth cycle may be issued to chip #3 and memory bank #0. After tRL since AR2-0 is issued, a data word D2-0 may appear on a DQB bus. The data word D2-0 may comprise data from chip #2 and memory bank #0. At a seventh clock cycle, a command AR4-0 comprising an action command and a read command for an eighth cycle may be issued to chip #4 and memory bank #0.

After tRL since AR3-0 is issued, a data word D3-0 may appear on a DQC bus. The data word D3-0 may comprise data from chip #3 and memory bank #0. At a ninth clock cycle, a command AR5-0 comprising an action command and a read command for an tenth cycle may be issued to chip #5 and memory bank #0. After tRL since AR4-0 is issued, a data word D4-0 may appear on a DQD bus. The data word D4-0 may comprise data from chip #4 and memory bank #0. At the tenth cycle, the system may enter a steady state, where at each subsequent clock cycle, an action or a read command may be issued, where the address/command bus 820 and the two data buses 830 may be fully (i.e., 100%) or substantially utilized.

To resolve driving power, output skew, and other signal integrity issues, a buffer may be used on an address/command and/or data buses. Such a scheme may add one or two cycles delay to a memory access. Alternatively or additionally, a command may be spaced to create a gap between data bursts on a shared data bus. For example, in the case of a DDR3 SDRAM, every two sets of read requests may be spaced by one idle clock cycle to create a gap of one clock cycle between two consecutive bursts on the shared data bus. This gap may help to compensate for the different clock jitters from the chips sharing the data bus. In such a scheme, the bandwidth utilization may be about 80 percent. For a DDRx SDRAM with a burst size of 16, every set of four read requests may be spaced by one idle clock cycle. There may be one idle cycle after every eight busy cycles on the data bus, such that the bandwidth utilization may be about 88.9 percent.

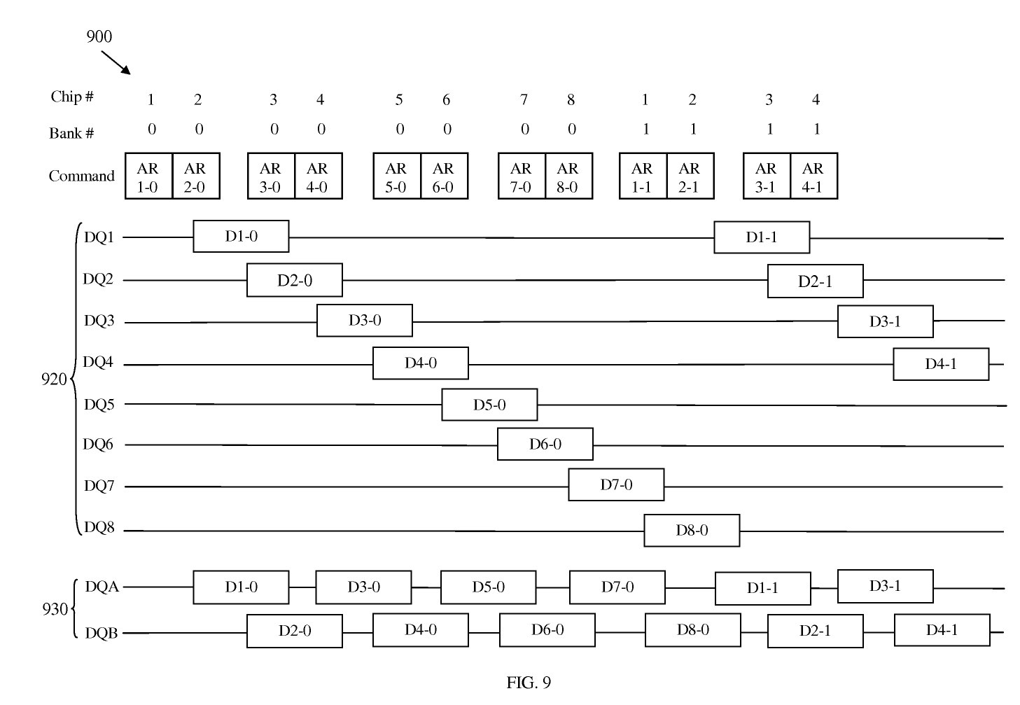

FIG. 9 illustrates an embodiment of a timing diagram 900 that may indicate the behavior of memory access patterns of a DDRx SDRAM architecture comprising about eight chips, with each chip coupled to about eight memory banks, e.g., based on the DDR3 SDRAM architecture 500. For example, chip #1, chip #2, chip #3, chip #4, chip #5, chip #6, chip #7, and chip #8 of the timing diagram 900 may correspond to chips 510, 512, 514, 516, 518, 520, 522, and 524 in the DDR3 SDRAM architecture 500, respectively. The timing diagram 900 shows an data bus 920 comprising eight I/O buses DQ1, DQ2, DQ3, DQ4, DQ5, DQ6, DQ7, and DQ8, where DQ1 is the I/O bus for chip #1, DQ2 is the I/O bus for chip #2, etc., and in addition two shared data buses 930, DQA and DQB. DQA is the shared data bus for chips 1, 3, 5, and 7 merging data buses DQ1, DQ3, DQ4, and DQ7. DQB is the shared data bus for chips 2, 4, 6, and 8 merging data buses DQ2, DQ4, DQ6, and DQ8. The timing diagram 900 also shows a plurality of data words and commands along a time axis, wherein the time axis may be represented by a horizontal line with time increasing from left to right. The data words and commands are represented as Di-j and ARi-j, respectively. The indexes i and j are integers, where i indicates a chip, and j indicates a memory bank. For example, D4-0 may correspond to a data word from chip #4 and a memory bank #0, and AR1-2 may indicate a command issued to chip #1 and a memory bank #2. The timing diagram 900 also shows the chip indices (“chip”) and bank indices (“bank”).

The timing diagram 900 indicates the temporal behavior of memory access patterns and commands of a DDRx SDRAM architecture comprising eight chips, such as the DDR3 SDRAM architecture 500. Each command ARi-j may comprise an active command issued in one clock cycle and a read command issued in a subsequent clock cycle. A command ARi-j may be issued to the same chip i, to memory bank j. Every two commands may be followed by a gap of one clock cycle. The commands may be issued in a round-robin scheme. The data words Di-j may be each about four cycles long and may be placed on the data buses 930. Note that the depicted architecture is used for table lookups (i.e. a memory read), therefore, the data Di-j are all read data from the memory chips.

At a first cycle, a command AR1-0 comprising an action command for the first cycle and a read command for a second cycle may be issued to chip #1 and memory bank #0. At a third cycle, a command AR2-0 comprising an action command for the third cycle and a read command for a fourth cycle may be issued to chip #2 and memory bank #0. At the beginning of a fourth clock cycle, a data word D1-0 may appear on a DQ1 pin of the address/command bus. The data word D1-0 may comprise an address or a command targeted to chip #1 and memory bank #0. At about the same time, in the fourth clock cycle, a data word D1-0 may appear on a DQA bus. The data word D1-0 may comprise data targeted to chip #1 and memory bank #0. At a sixth clock cycle, a command AR3-0 comprising an action command and a read command for a seventh cycle may be issued to chip #3 and memory bank #0. At the beginning of the sixth clock cycle, a data word D2-0 may appear on a DQ2 pin of the address/command bus. The data word D2-0 may comprise an address or a command targeted to chip #1 and memory bank #0. At about the same time, at the sixth clock cycle, a data word D2-0 may appear on a DQB bus. The data word D2-0 may comprise data targeted to chip #2 and memory bank #0. At the sixth cycle, the system may enter a steady state, where at each subsequent clock cycle, an action or a read command or a gap may be issued, where the address/command bus 920 and the two data buses 930 may be 80 percent or substantially utilized. In the case of a DDR4 SDRAM, since the burst size may be 16 bits wide, every set of four read requests may be spaced by one idle clock cycle. In such a scheme, there may be one idle cycle after every about eight busy cycles, and the bandwidth utilization may be 88.9 percent.

Compared to a DDR3 SDRAM that comprises an 8-bit pre-fetch size or burst size, a DDR4 SDRAM may have a higher I/O frequency and may use a 16-bit pre-fetch size. In a DDR4 SDRAM, a burst may need about eight clock cycles to transfer, during which about four read commands may be issued. For this reason, at least about four chips may be grouped together to share four data buses, in contrast to the two buses that may be shared in the case of a DDR3 SDRAM. On the other hand, the DDR3 SDRAM and the DDR4 SDRAM may have substantially identical schemes to increase lookup performance in terms of number of searches per second, e.g., based on different I/O frequencies. A DDR4 chip may have substantially the same data bus width as a DDR3 chip, and thus each read request may retrieve twice as many data from a memory. If the width of a data bus on a DDR4 chip is reduced to half, then the DDRx SDRAM configurations based on both DDR3 and DDR4 may have a substantially similar number of pins and substantially the same memory transaction size (e.g., a data unit size for both an x8 DDR4 and a x16 DDR3 may be about 128-bits).

The disclosed improved DDRx SDRAM systems reduce the number of pins (or maximize the pin bandwidth utilization) that are used between the search engine/logic unit (FPGA or ASIC or NPU) and the external memory module. For example, in some embodiments, the address bus and data bus from the logic unit are fed to multiple DDRx chips (i.e. multiple DDR chips share the same bus). Thus, the pin count on the logic unit side (e.g., DDRx SDRAM controller 310) is saved while the high bandwidth efficiency is also achieved through the chip/bank scheduling scheme.

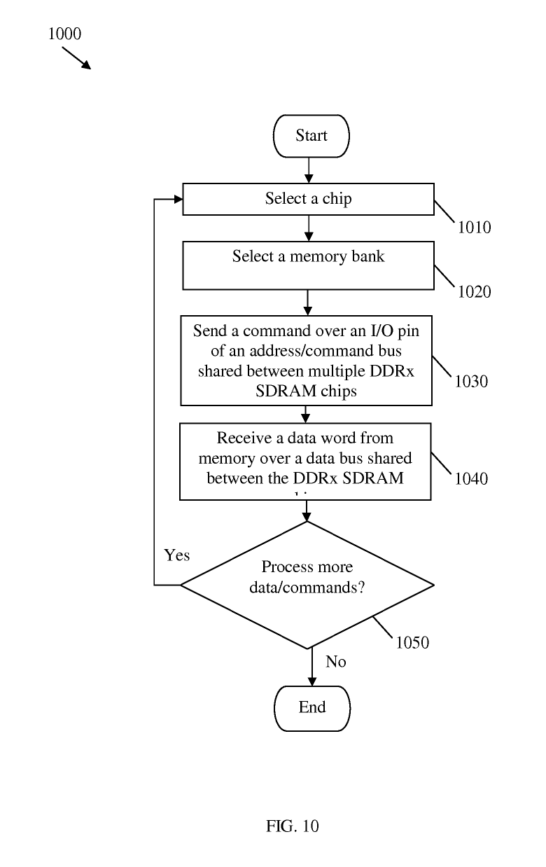

FIG. 10 illustrates an embodiment of a table lookup method 1000, which may be implemented by a DDRx SDRAM system that may use the bus sharing and bank replication schemes described above. For instance, the table lookup method 1000 may be implemented using the DDRx SDRAM system 300 or the DDRx SDRAM system 400. The method 1000 may begin at block 1010, where a chip may be selected. In an embodiment, the chip may be selected by a controller via a chip select signal. At block 1020, a memory bank may be selected. The selection of the memory bank may be based on criteria such as timing parameters, e.g., tRC, tFAW, and tRDD. At block 1030, a data word may be sent over an I/O pin of an address/command bus shared between multiple DDRx SDRAM chips. The address/command bus may be a bus shared by a plurality of chips and configured to transport both addresses and commands, such as the Addr/Ctrl link 320 or the Addr/Ctrl link 420. At block 1040, a data word may be sent over a data bus shared between the DDRx SDRAM chips. The width of the data bus may be about 16 bits. The data bus may be a bus shared by the same chips that share the address/command bus and configured to transport data, such as the data buses 326 and 334 in the DDRx SDRAM system 300 and the data buses 426, 442, 468, and 474 in the DDRx SDRAM system 400. At block 1050, the method 300 may determine whether to process more data/commands. If the condition in block 380 is met, then the table lookup method 1000 may return to block 1010. Otherwise, the method 1000 may end.

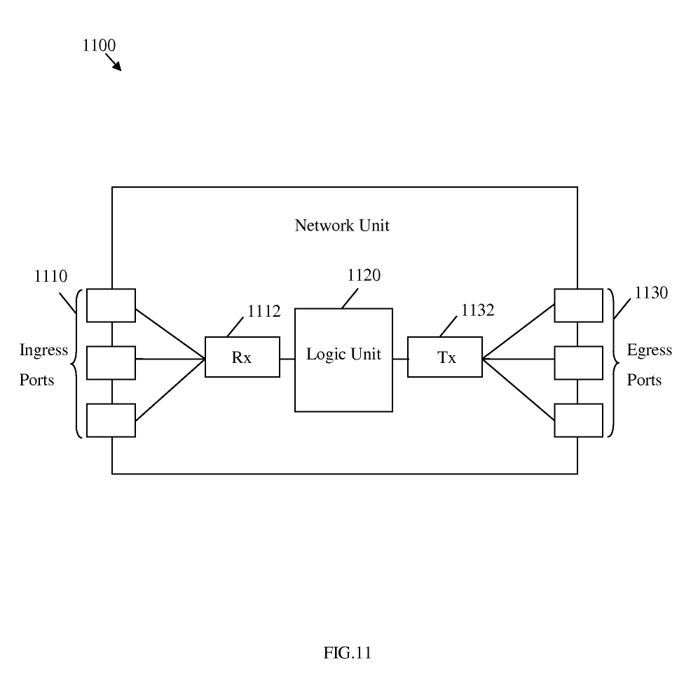

FIG. 11 illustrates an embodiment of a network unit 1100, which may be any device that transports and processes data through a network. The network unit 1100 may comprise or may be coupled to and use a DDRx SDRAM system that may be based on the DDRx SDRAM architecture 500 or the DDRx SDRAM architecture 700. For instance, the network unit 1100 may comprise the SDRAM systems 300 or 400, e.g., at a central office or a network that comprises one of more memory systems. The network unit 1100 may comprise one or more ingress ports or units 1110 coupled to a receiver (Rx) 1112 for receiving packets, objects, or Type Length Values (TLVs) from other network components. The network unit 1100 may comprise a logic unit 1120 to determine which network components to send the packets to. The logic unit 1120 may be implemented using hardware, software, or both, and may implement or support the table lookup method 1000. The network unit 1100 may also comprise one or more egress ports or units 1130 coupled to a transmitter (Tx) 1132 for transmitting frames to the other network components. The components of the network unit 1100 may be arranged as shown in FIG. 11.

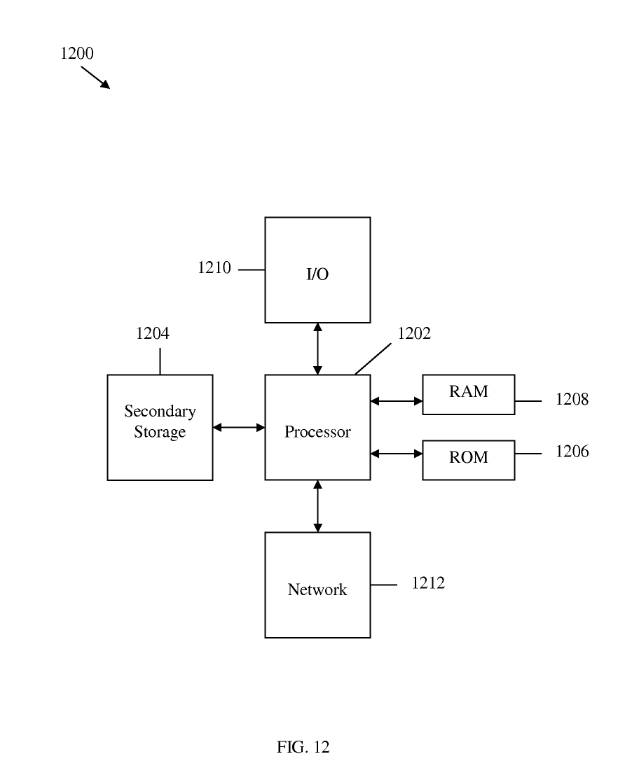

The network components described above may be implemented in a system that comprises any general-purpose network component, such as a computer or network component with sufficient processing power, memory resources, and network throughput capability to handle the necessary workload placed upon it. FIG. 12 illustrates a typical, general-purpose network component 1200 suitable for implementing one or more embodiments of the components disclosed herein. The network component 1200 includes a processor 1202 (which may be referred to as a central processor unit or CPU) that is in communication with memory devices including secondary storage 1204, read only memory (ROM) 1206, random access memory (RAM) 1208, input/output (I/O) devices 1210, and network connectivity devices 1212. The processor 1202 may be implemented as one or more CPU chips, or may be part of one or more Application-Specific Integrated Circuits (ASICs).

The secondary storage 1204 is typically comprised of one or more disk drives or tape drives and is used for non-volatile storage of data and as an overflow data storage device if RAM 1208 is not large enough to hold all working data. Secondary storage 1204 may be used to store programs that are loaded into RAM 1208 when such programs are selected for execution. The ROM 1206 is used to store instructions and perhaps data that are read during program execution. ROM 1206 is a non-volatile memory device that typically has a small memory capacity relative to the larger memory capacity of secondary storage 1204. The RAM 1208 is used to store volatile data and perhaps to store instructions. Access to both ROM 1206 and RAM 1208 is typically faster than to secondary storage 1204.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 5, 4, etc.; greater than 0.10 includes 0.11, 0.12, 0.15, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 5 percent, 4 percent, 5 percent, . . . , 50 percent, 51 percent, 52 percent, . . . , 75 percent, 76 percent, 77 percent, 78 percent, 77 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus comprising:
a plurality of memory components each comprising a plurality of memory banks;
a memory controller coupled to the memory components and configured to control and select one of the plurality of memory components for a memory operation;
a plurality of address/command buses coupled to the plurality of memory components and the memory controller comprising at least one shared address/command bus between at least some of the plurality of memory components; and
a plurality of data buses coupled to the memory components and the memory controller comprising at least one data bus between at least some of the memory components,
wherein the memory controller uses a memory interleaving and bank arbitration scheme in a time-division multiplexing (TDM) fashion to access the plurality of memory components and the memory banks, and
wherein the memory components comprise a generation of a Double Data Rate (DDR) Synchronous Dynamic Random Access Memory (SDRAM).

2. The apparatus of claim 1, wherein the plurality of memory components comprise a plurality of Double Data Rate (DDR) Synchronous Dynamic Random Access Memory (SDRAM) chips.

3. The apparatus of claim 2, wherein the memory interleaving and bank arbitration scheme is used to scale up the table lookup performance of the plurality of memory components, and wherein the shared address/command bus and the shared data bus are used to reduce the number of Input/Output (I/O) pins needed and used on a logic unit coupled to the memory components.

4. The apparatus of claim 1, wherein the plurality of memory components are grouped into a plurality of component groups that are each coupled to the memory controller by a shared data bus.

5. The apparatus of claim 4, wherein all the component groups are coupled to the memory controller by a shared address/command bus.

6. The apparatus of claim 4, wherein the component groups that share at least a data bus and an address/command bus are packaged using die-stacking without a serializer/deserializer (SerDes).

7. The apparatus of claim 2, wherein the DDRx SDRAM chips comprise a plurality of DDR3 SDRAM chips, a plurality of DDR4 SDRAM chips, or combinations of both.

8. The apparatus of claim 2, wherein the DDRx SDRAM chips are DDR3 SDRAM chip that have inherent timing constraints comprising a Four Activate Window time (tFAW) of about 40 nanosecond (ns), a row-to-row delay time (tRRD) of about 10 ns, and a row cycling time (tRC) of about 48 ns.

9. The apparatus of claim 2, wherein the memory controller is coupled to two chip groups that each comprise two DDR3 SDRAM chips via two corresponding shared data buses and a shared address/command bus, wherein each of the DDR3 SDRAM chips is coupled to the memory controller via a clock signal bus and a chip select signal bus, and wherein the DDR3 SDRAM chips have total Input/Output (I/O) frequency of about 800 Megahertz (MHz) and a table lookup performance of about 400 Million packets per second (Mpps).

10. The apparatus of claim 2, wherein the memory controller is coupled to four chip groups that each comprise two DDR SDRAM chips with burst size of 16 via four corresponding shared data buses and a shared address/command bus, wherein each of the DDR SDRAM chips is coupled to the memory controller via a clock signal bus and a chip select signal bus, and wherein the DDR SDRAM chips have a total Input/Output (I/O) frequency of about 1.6 Gigahertz (GHz) and a table lookup performance of about 800 Million packets per second (Mpps).

11. A network component comprising:
a receiver configured to receive a plurality of table lookup requests; and
a logic unit configured to generate a plurality of commands indicating access to a plurality of interleaved memory chips and a plurality of interleaved memory banks for the chips via at least one shared address/command bus and one shared data bus.

12. The network component of claim 11, wherein the memory chips that share an address/command bus and a data bus are accessed in an alternating manner, and wherein the memory chips that do not share any buses are accessed in a parallel manner.

13. The network component of claim 11, wherein at least some of the plurality of memory chips comprise about two Double Data Rate (DDR) Synchronous Dynamic Random Access Memory (SDRAM) chips configured to have an Input/Output (I/O) frequency of about 400 Megahertz (MHz) and a table lookup throughput of about 200 Mega searches per second (Msps) without adding additional pins to the memory chips.

14. The network component of claim 11, wherein the memory chips comprise about four Double Data Rate (DDR) Synchronous Dynamic Random Access Memory (SDRAM) chips configured to have an Input/Output (I/O) frequency of about 800 Megahertz (MHz) and a table lookup throughput of about 400 Mega searches per second (Msps) by adding two pins to the memory chips for chip select signals.

15. The network component of claim 11, wherein the memory chips comprise about six Double Data Rate (DDR) Synchronous Dynamic Random Access Memory (SDRAM) chips configured to have an Input/Output (I/O) frequency of about 1066 Megahertz (MHz) and a table lookup throughput of about 533 Mega searches per second (Msps) by adding four pins to the memory chips for chip select signals.

16. The network component of claim 11, wherein the memory chips comprise about eight Double Data Rate (DDR) Synchronous Dynamic Random Access Memory (SDRAM) chips configured to have an Input/Output (I/O) frequency of about 1.6 Gigahertz (GHz) and a table lookup throughput of about 800 Mega searches per second (Msps) by adding six pins to the memory chips for chip select signals.

17. The network component of claim 11, wherein the memory chips comprise about 16 Double Data Rate (DDR) Synchronous Dynamic Random Access Memory (SDRAM) chips configured to have an Input/Output (I/O) frequency of about 3.2 Gigahertz (GHz) and a table lookup throughput of about 1.6 Mega searches per second (Gsps) by adding six pins to the memory chips for chip select signals.

18. A network apparatus implemented method comprising:
selecting a memory chip from a plurality of memory chips using a memory controller;
selecting a memory bank from a plurality of memory banks assigned to the memory chips using the memory controller;
sending a command over an Input/Output (I/O) pin of an address/command bus shared between some of the memory chips; and
sending a data word over a data bus shared between the some of the memory chips,
wherein the command is sent over the shared address/command bus and the data word is sent over the shared data bus in a multiplexing scheme.

19. The network apparatus implemented method of claim 18, wherein all the memory chips are identical, and wherein a plurality of memory banks are replicated for each of the memory chips to support one or more lookup tables.

20. The network apparatus implemented method of claim 19, wherein eight memory banks are replicated to support one lookup table, four memory banks are replicated to support two lookup tables, or two memory banks are replicated to support four lookup tables.

21. The network apparatus implemented method of claim 18, wherein all the memory chips are identical, and wherein no memory banks are replicated for the memory chips.
